(19) United States
(12) Patent Application Publication
(10) Pub. No.: US 2005/0121418 A1
(43) Pub. Date: Jun. 9, 2005

(54) Gas-insulated switchgear

(75) Inventor: Tomotaka Yano, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/866,768

(22) Filed: Jun. 15, 2004

(30) Foreign Application Priority Data
Dec. 8, 2003 (JP) P2003-409157

(51) Int. Cl. H01H 9/40

(52) U.S. Cl. 218/7

(57) ABSTRACT

A gas-sealing member 22 surrounds an opening 5b of a hermetically sealed container 2 and is brought into airtight contact with periphery of the opening 5b. An outer gas seal guide 20 holds the gas-sealing member 22 surrounding the outer circumference of the member 22 and brings the member 22 into contact with the periphery of the opening 5b. An inner gas seal guide 21 holds the gas-sealing member 22 along inner circumference of the member 22 and brings the gas-sealing member 22 into contact with the periphery of the opening 5b. The gas-sealing member 22, outer gas seal guide 20 and inner gas seal guide 21 are disposed between the periphery of the opening 5b of the hermetically sealed container 2 and a member airtightly connected to the periphery of the opening, thus establishing an airtight connection between the periphery of the opening 5b and the member airtightly connected.

### BACKGROUND OF THE INVENTION

1. Field of the Invention

The present invention relates to a gas-insulated switchgear in which electrical components are accommodated in a hermetically sealed container filled with insulating gas and, more particularly, to gas sealing thereof.

2. Description of the Related Art

In a conventional gas-insulated switchgear provided with a hermetically sealed container, in which switching unit or electrical components such as circuit breaker, disconnector, grounding switch, load switch or the like are accommodated, a gas seal groove is provided on any of one hermetically sealed container, another hermetically sealed container, a flange, a bushing and so on. Further, a gas-sealing member such as packing or O-ring is disposed in the gas seal groove, thus forming an airtight connection (see the Japanese Utility Model publication (unexamined) No. 1981-114587, for example).

In the conventional gas-insulated switchgear, since a gas seal groove is used, it is essential that the hermetically sealed container, flange, bushing or the like be provided with a plate of sufficient thickness. As a result, a problem exists in that the hermetically sealed container, flange, bushing or the like increases in weight as well as in cost due to complexity in processing the gas seal groove.

### SUMMARY OF THE INVENTION

The present invention was made to solve the above-discussed problems and has an object of obtaining a gas-insulated switchgear in which a hermetically sealed container, flange, bushing or the like is light in weight, and processing of the hermetically sealed container, flange, or bushing is easy, eventually resulting in cost saving.

A gas-insulated switchgear according to the invention includes a hermetically sealed container filled with insulating gas and in which electrical components are accommodated. In this gas-insulated switchgear, a gas-sealing member that surrounds an opening of the mentioned hermetically sealed container and is brought into airtight contact with periphery of the mentioned opening is disposed between the periphery of the opening of the mentioned hermetically sealed container and a member air-tightly connected to the periphery of the opening. Further, an outer gas seal guide that holds the mentioned gas-sealing member surrounding outer circumference of the mentioned gas-sealing member, and brings the mentioned gas-sealing member into contact with the periphery of the mentioned opening, is also disposed between the periphery of the opening of the mentioned hermetically sealed container and the member air-tightly connected to the periphery of the opening. Furthermore, an inner gas seal guide that holds the mentioned gas-sealing member along inner circumference of the mentioned gas-sealing member and brings the mentioned gas-sealing member into contact with the periphery of the mentioned opening, is also disposed between the periphery of the opening of the mentioned hermetically sealed container and the member air-tightly connected to the periphery of the opening. Thus, airtight connection is established between periphery of the opening of the mentioned hermetically sealed container and the mentioned member air-tightly connected to the periphery of the opening.

In the gas-insulated switchgear of above construction according to the invention, it is not necessary to provide any groove of the gas-sealing member on the periphery of the opening of the hermetically sealed container or on the member air-tightly connected to the periphery of the opening, eventually resulting in easy processing and cost saving.

Another gas-insulated switchgear according to the invention also includes a hermetically sealed container filled with insulating gas and in which electrical components are accommodated. In this gas-insulated switchgear, a gas-sealing member that surrounds an opening of the mentioned hermetically sealed container and is brought into airtight contact with periphery of the mentioned opening is disposed between the periphery of the opening of the mentioned hermetically sealed container and a member air-tightly connected to the periphery of the opening. Further, an outer gas seal guide that is held with a bolt that is provided on either the periphery of the mentioned opening or a member air-tightly connected to provide a connection between them, holds the mentioned gas-sealing member surrounding outer circumference of the mentioned gas-sealing member, and brings the mentioned gas-sealing member into contact with the periphery of the mentioned opening is disposed between the periphery of the opening of the mentioned hermetically sealed container and a member air-tightly connected to the periphery of the opening. Furthermore, an inner gas seal guide that holds the mentioned gas-sealing member along inner circumference of the mentioned gas-sealing member and brings the mentioned gas-sealing member into contact with the periphery of the mentioned opening is also disposed between the periphery of the opening of the mentioned hermetically sealed container and the member air-tightly connected to the periphery of the opening. Thus, airtight connection is secured between periphery of the opening of the mentioned hermetically sealed container and the mentioned member air-tightly connected to the periphery of the opening.

In the gas-insulated switchgear of above construction according to the invention, the outer gas seal guide that surrounds the outer circumference of the gas-sealing member and brings the gas-sealing member into contact with the periphery of the opening is held with the bolt that is provided on either the periphery of the mentioned opening or on the mentioned member air-tightly connected to connect the periphery and the member. As a result, work efficiency is improved and the gas-sealing member can be stably held.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view showing a gas-insulated switchgear according to Embodiment 1 of the present invention.

FIG. 2 is an exploded perspective view showing a portion where a gas-sealing flange is mounted in an opening of a hermetically sealed container of the gas-insulated switchgear in FIG. 1.

FIG. 3 is a perspective view showing the portion of FIG. 2 where the gas-sealing flange is mounted.

FIG. 4 is an enlarged sectional view of a gas-sealing flange gas seal portion showing an essential part of Embodiment 1.

FIG. 5 is an enlarged sectional view of a gas-sealing vessel gas seal portion showing an essential part of Embodiment 2.

### DETAILED DESCRIPTION OF THE INVENTION

### Embodiment 1

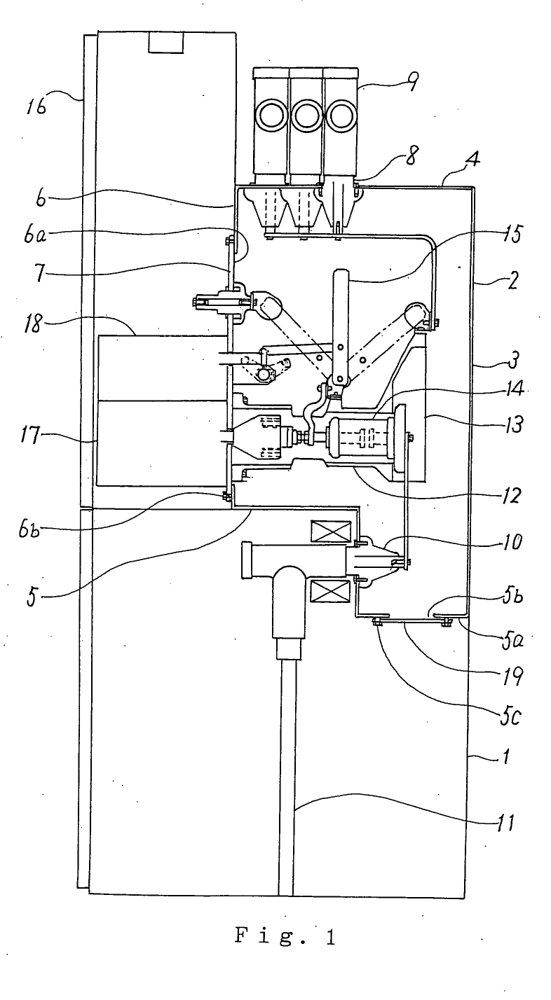

Referring now to FIG. 1 being a sectional view showing a gas-insulated switchgear according to Embodiment 1 of this invention, a hermetically sealed container 2, which is hermetically sealed and filled with insulating gas such as SF₆ gas, is supported on a stand 1. The hermetically sealed container 2 includes a cylindrical shell plate part 3, a top plate part 4 covering an opening at the top of the shell plate part 3, a bottom plate part 5 covering an opening at the bottom of the shell plate part 3, and a gas-sealing flange 19 covering an opening 5b of the bottom plate part 5. The bottom plate part 5 is provided with a protrusion 5a protruding downward so as to extend the internal space of the hermetically sealed container 2. Plural stud bolts 5c are welded to the periphery of the opening 5b of the protrusion 5a.

The shell plate part 3 also includes a front shell plate part 6 and a gas-sealing flange 7 fixed to this front shell plate part 6. The front shell plate part 6 is provided with an opening 6a, and plural stud bolts 6a are welded to the periphery of this opening 6a. The top plate part 4A is provided with a three-phase bus bar bushing 8. A bus bar connector 9 is connected to the bus bar bushing 8A. The protrusion 5a A is provided with a cable bushing 10. A cable 11 is connected to the cable bushing 10.

A circuit breaker 12 for electrically connecting and disconnecting the circuit between the bus bar connector 9 and the cable 11 is accommodated in the hermetically sealed container 2. The circuit breaker 12 is held in an insulating holder 13 fixed to the gas-sealing flange 7 and has a vacuum valve 14 acting as an arc-extinguishing chamber of the circuit breaker. Further, a disconnector/grounding switch 15 for connecting, disconnecting, and grounding the circuit between the circuit breaker 12 and the bus bar connector 9 is accommodated in the hermetically sealed container 2. A panel 16 is fixed to a front face of the hermetically sealed container 2. The panel 16 is fixed to the hermetically sealed container 2 utilizing the stud bolts 6b for fixing the gas-sealing flange 7 or utilizing stud bolts (not shown in the drawing) welded to the front face of the hermetically sealed container 2 and used exclusively for fixing the panel.

A circuit breaker operating mechanism 17, a disconnector/grounding switch operating mechanism 18, and a control unit (not shown) are accommodated in the panel 16. The circuit breaker operating mechanism 17 and the disconnector/grounding switch operating mechanism 18 are mounted on the gas-sealing flange 7 utilizing plural stud bolts welded to the gas-sealing flange 7. In addition, it is general that switching apparatus or electrical components such as circuit breaker, disconnector, grounding switch, and a load switch are accommodated in the hermetically sealed container of the gas-insulated switchgear.

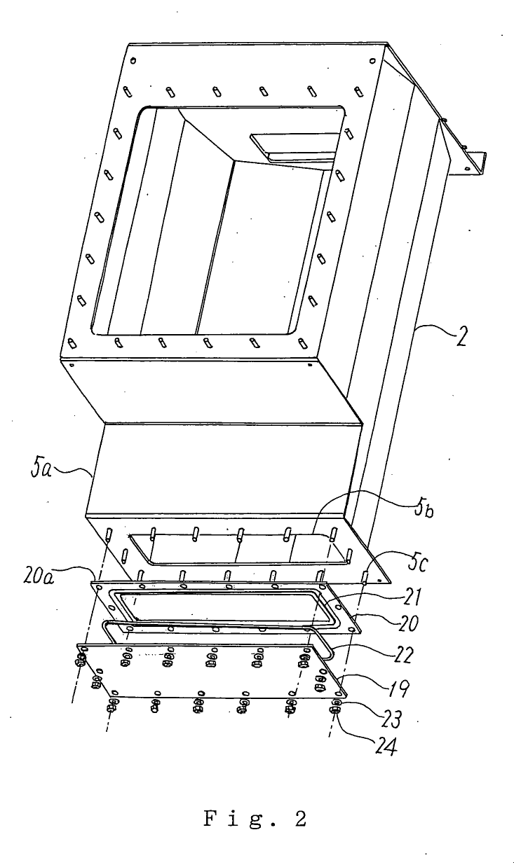

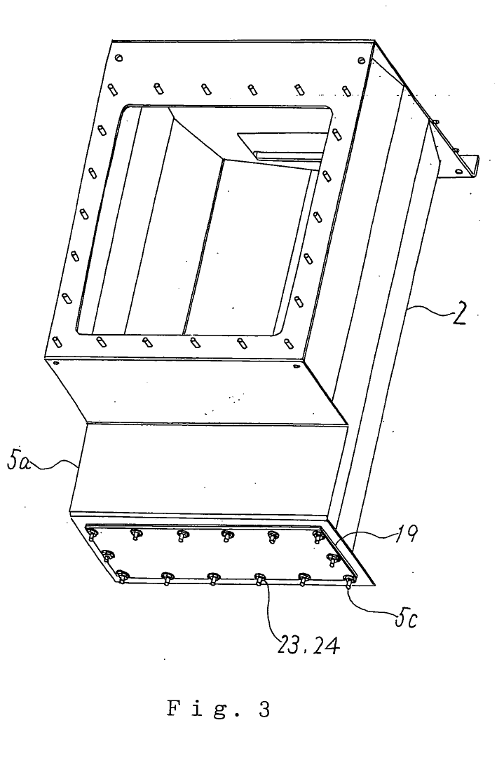

FIG. 2 is an exploded perspective view showing a portion where the gas-sealing flange is mounted in the opening of the hermetically sealed container of the gas-insulated switchgear in FIG. 1, and FIG. 3 is a perspective view showing the portion of FIG. 2 where the gas-sealing flange is mounted. Referring to FIGS. 2 and 3, the plural stud bolts 5c are welded to the periphery of the opening 5b disposed on the protrusion 5a of the bottom plate part 5 of the hermetically sealed container 2. Reference numeral 22 is a gas-sealing member such as n O-ring or packing made of rubber. The gas-sealing member 22 surrounds the opening 5b of the hermetically sealed container 2 and is brought into contact with the periphery of the opening 5b.

An outer gas seal guide 20 holds the gas-sealing member 22 surrounding the outer circumference of the gas-sealing member 22 and brings the gas-sealing member 22 into contact with the periphery of the opening 5b of the hermetically sealed container 2. The outer gas seal guide 20 is provided with through holes 20a corresponding to the position of the plural stud bolts 5c. By passing the stud bolts 5c through the through holes 20a, the outer gas seal guide 20 is positioned and held by the stud bolts 5c. An inner gas seal guide 21 holds the gas-sealing member 22 along the inner circumference of the gas-sealing member 22 and brings the gas-sealing member 22 into contact with the periphery of the opening 5b of the hermetically sealed container 2. In this manner, the gas-sealing member 22 is held by the outer gas seal guide 20 from outer circumference side, held by the inner gas seal guide 21 from inner circumference side, and brought into contact with the periphery of the opening 5b of the hermetically sealed container 2. The outer gas seal guide 20 and the inner gas seal guide 21 are made of an iron material such as stainless steel.

The gas-sealing member 22, the outer gas seal guide 20 and the inner gas seal guide 21 are held between the gas-sealing flange 19 and the periphery of the opening 5b of the hermetically sealed container 2, and plural washers 23 and plural nuts 24 are used to fix the gas-sealing flange l9 on the plural studbolts 5c, thus achieving an airtight connection to the hermetically sealed container 2. In addition, it is also preferable to use another hermetically sealed container, any bushing or the like as the member airtightly connected to the periphery of the opening 5b of the hermetically sealed container 2, instead of the flange.

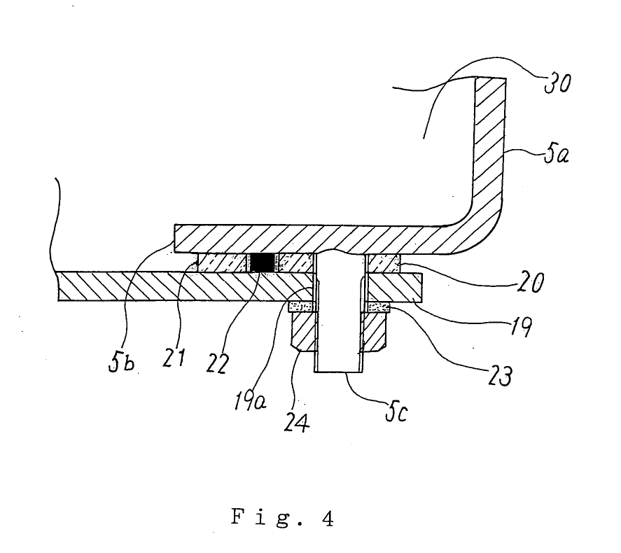

FIG. 4 is an enlarged sectional view of the gas-sealing flange gas seal portion showing an essential part of Embodiment 1. The stud bolt 5c is welded to the periphery of the opening 5b formed on the protrusion 5a of the bottom plate part of the hermetically sealed container 2. Numeral 30 is an internal part of the hermetically sealed container 2. The outer circumference of the gas-sealing member 22 is surrounded by and held on the outer gas seal guide 20. The outer gas seal guide 20 is positioned and held by inserting the stud bolt 5c in the through holes of the outer gas seal guide 20. The inner gas seal guide 21 holds the gas-sealing member 22 along the inner circumference of the gas-sealing member 22. The stud bolt 5c is inserted in through holes 19a provided at a position corresponding to the stud bolts 5c, and the gas-sealing member 22, the outer gas seal guide 20 and the inner gas seal guide 21 are held between the gas-sealing flange 19 and the periphery of the opening 5b of the hermetically sealed container 2, and the plural washers 23 and plural nuts 24 are used to fix the gas-sealing flange 19 to the plural stud bolts 5c, thus the gas-sealing flange 19 being air-tightly connected to the hermetically sealed container 2. In addition, the gas-sealing flange 19 acts as a member air-tightly connected to the periphery of the opening 5b of the hermetically sealed container 2. Although the outer gas seal guide 20 is positioned and held by inserting the stud bolts 5c in the through holes, it is also preferable to position and hold the inner gas seal guide 21 by providing through holes through the inner gas seal guide 21, instead of the outer gas seal guide 20, and inserting the stud bolts 5c in the through holes in the same manner. It is also preferable to weld the stud bolts 5c to the gas-sealing flange 19 side and provide through holes for the stud bolts 5c on the hermetically sealed container 2 side, instead of welding the stud bolts 5c to the hermetically sealed container 2.

In the gas-insulated switchgear described above, the gas-sealing member such as packing or O-ring is held between the periphery of the opening of the hermetically sealed container and the gas-sealing flange by disposing the outer gas seal guide and the inner gas seal guide respectively on the outer and inner circumferences of the gas-sealing member without use of any gas seal groove, thus achieving an airtight connection between them. As a result, processing of the gas-insulated switchgear is easy and cost thereof is reduced. Since the outer gas seal guide is positioned by the stud bolts, work efficiency is improved and the gas-sealing member is stably held.

### Embodiment 2

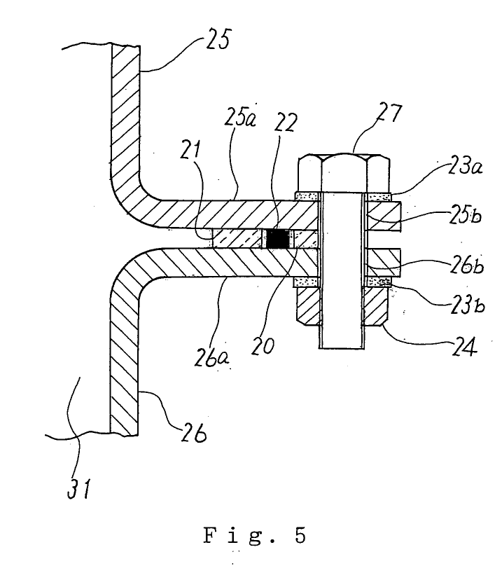

FIG. 5 is an enlarged sectional view of a gas-sealing vessel gas seal portion showing an essential part of Embodiment 2. In the drawing, the same numerals indicate the same or like parts. Referring to FIG. 5, ends of a first hermetically sealed container 25 and a second hermetically sealed container 26 facing each other are bent to be formed into L-shaped portions 25a and 26a respectively, and ends of the L-shaped portions 25a and 26a are provided with through holes 25b and 26b for fastening with a bolt. Numeral 31 is an internal part of the hermetically sealed container. The L-shaped portion 25a of the first hermetically sealed container 25 serves as the periphery of the opening of the hermetically sealed container. The L-shaped portion 26a of the second hermetically sealed container 26 serves as the member airtightly connected to the periphery of the opening. The outer gas seal guide 20 is surrounded and held by the gas-sealing member 22 at the outer circumference thereof. A bolt 27 regulates the position of the outer circumference of the outer gas seal guide 20 and holds the outer gas seal guide 20. The inner gas seal guide 21 holds the gas-sealing member 22 along the inner circumference of the gas-sealing member 22.

The gas-sealing member 22, and the outer gas seal guide 20 holding the outer circumference side and the inner gas seal guide 21 holding the inner circumference side are positioned by the bolt 27 passing through the through holes 25b and 26b and are held between the L-shaped portion 25a of the first hermetically sealed container 25 and the L-shaped portion 26a of the second hermetically sealed container 26. The L-shaped portion 25a of the first hermetically sealed container 25 and the L-shaped portion 26a of the second hermetically sealed container 26 are fixed with the bolt 27, washers 23a and 23b and nuts 24, thus an airtight connection being provided between them.

In the gas-insulated switchgear described above, the gas-sealing member such as packing or O-ring is held between the periphery of the opening of the hermetically sealed container and the periphery of the opening of the other hermetically sealed container by disposing the outer gas seal guide and the inner gas seal guide respectively on the outer and inner circumferences of the gas-sealing member without use of any gas seal groove, thus achieving an airtight connection between them. As a result, processing of the gas-insulated switchgear is easy and cost thereof is reduced. Since the outer gas seal guide is positioned by the stud bolts, work efficiency is improved and the gas-sealing member is stably held.

### Embodiment 3

In this invention, it is unnecessary to form any gas seal groove for a gas-sealing member on the hermetically sealed container or a member air-tightly connected to the hermetically sealed container, and therefore it possible to reduce thickness of the plate of the hermetically sealed container or the member air-tightly connected to the hermetically sealed container. Accordingly, it is preferable to form the hermetically sealed container or the member airtightly connected to the hermetically sealed container employing a thin plate of not more than 6 mm in thickness. Any thin plate of such thickness is enough to form a gas seal groove and easily pressed. As a result, it is possible to reduce weight and save the cost.

This invention makes it possible to reduce thickness of the plate forming the heavy hermetically sealed container, and is therefore applicable to gas-insulated switchgears of various insulating gases, gas pressures and rated voltages, and it is possible to reduce weight and save the cost.

While the presently preferred embodiments of the present invention have been shown and described, it is to be understood that these disclosures are for the purpose of illustration and that various changes and modifications may be made without departing from the scope of the invention as set forth in the appended claims.

1. A gas-insulated switchgear including a hermetically sealed container filled with insulating gas and in which electrical components are accommodated;
said gas-insulated switchgear comprising: a gas-sealing member that surrounds an opening of said hermetically sealed container and is brought into airtight contact with periphery of said opening; an outer gas seal guide that holds said gas-sealing member surrounding an outer circumference of said gas-sealing member and brings said gas-sealing member into contact with the periphery of said opening; and an inner gas seal guide that holds said gas-sealing member along inner circumference of said gas-sealing member and brings said gas-sealing member into contact with the periphery of said opening;
wherein said gas-sealing, said outer gas seal guide and said inner gas seal guide are disposed between the periphery of the opening of said hermetically sealed container and a member air-tightly connected to the periphery of the opening so that airtight connection is established between the periphery of the opening of said hermetically sealed container and said member air-tightly connected to the periphery of the opening.

2. The gas-insulated switchgear according to claim 1, wherein said outer gas seal guide is provided with through holes at positions corresponding to stud bolts that are disposed on the periphery of said opening and said member air-tightly connected to provide a connection between them, whereby said outer gas seal guide is positioned and held by passing said stud bolts through the through holes of said outer gas seal guide.

3. The gas-insulated switchgear according to claim 1, wherein said inner gas seal guide is provided with through holes at positions corresponding to stud bolts that are disposed on the periphery of said opening and said member air-tightly connected to provide a connection between them, whereby said inner gas seal guide is positioned and held by passing said stud bolts through the through holes of said inner gas seal guide.

4. The gas-insulated switchgear according to claim 1, wherein said hermetically sealed container or said member airtightly connected to said hermetically sealed container is formed of a thin plate of not more than 6 mm in thickness.

5. A gas-insulated switchgear including a hermetically sealed container filled with insulating gas and in which electrical components are accommodated;
said gas-insulated switchgear comprising: a gas-sealing member that surrounds an opening of said hermetically sealed container and is brought into airtight contact with periphery of said opening; an outer gas seal guide that is held with a bolt that is provided on either the periphery of said opening or a member air-tightly connected to provide a connection between them, holds said gas-sealing member surrounding an outer circumference of said gas-sealing member, and brings said gas-sealing member into contact with the periphery of said opening; and an inner gas seal guide that holds said gas-sealing member along inner circumference of said gas-sealing member and brings said gas-sealing member into contact with the periphery of said opening;
wherein said gas-sealing member, said outer gas seal guide and said inner gas seal guide are disposed between the periphery of the opening of said hermetically sealed container and a member air-tightly connected to the periphery of the opening so that airtight connection is established between periphery of the opening of said hermetically sealed container and said member air-tightly connected to the periphery of the opening.

6. A gas-insulated switchgear including a hermetically sealed container filled with insulating gas and in which electrical components are accommodated;
said gas-insulated switchgear comprising: a gas-sealing member that surrounds an opening of said hermetically sealed container and is brought into airtight contact with periphery of said opening; an outer gas seal guide that holds said gas-sealing member surrounding an outer circumference of said gas-sealing member and brings said gas-sealing member into contact with the periphery of said opening; and an inner gas seal guide that is held with a bolt that is provided on either the periphery of said opening or a member air-tightly connected to provide a connection between them, holds said gas-sealing member along inner circumference of said gas-sealing member, and brings said gas-sealing member into contact with the periphery of said opening;
wherein said gas-sealing member, said outer gas seal guide and said inner gas seal guide are disposed between the periphery of the opening of said hermetically sealed container and a member air-tightly connected to the periphery of the opening so that airtight connection is established between periphery of the opening of said hermetically sealed container and said member air-tightly connected to the periphery of the opening.
